(19) United States
(12) Patent Application Publication
(10) Pub. No.: US 2013/0266395 A1
(43) Pub. Date: Oct. 10, 2013

(54) LOCKNUT WITH SEGMENTED RING

(71) Applicant: INDUSTRIAL NUT CORP., Sandusky, OH (US)

(72) Inventors: Gary L. Schuster, Huron, OH (US); John William Springer, Huron, OH (US)

(73) Assignee: Industrial Nut Corp., Sandusky, OH (US)

(21) Appl. No.: 13/858,459

(22) Filed: Apr. 8, 2013

Related U.S. Application Data
(60) Provisional application No. 61/621,079, filed on Apr. 6, 2012.

(51) Int. Cl. F16B 39/24

(52) U.S. Cl. CPC F16B 39/24
USPC 411/216

(57) ABSTRACT

A locknut and ring assembly has a locknut including a body having an internal bore having threads therein and the threads extend between the first and second opposed outer ends of the locknut. A groove is formed in the internal bore at one of at least several positions spaced from the first and second opposed ends. A segmented locking insert is inserted into the groove.

### CLAIM OF PRIORITY

This application claims priority from Provisional Patent Application Ser. No. 61/621,079, filed on Apr. 6, 2012, the entirety of which is hereby incorporated by reference.

### BACKGROUND OF THE DISCLOSURE

The disclosure relates to locknuts. More particularly, it relates to a prevailing torque lock nut with a segmented nylon insert.

There are currently three basic designs for prevailing-torque nuts: a) all-metal, one piece construction nuts which derive their prevailing-torque characteristics from controlled distortion of the nut thread and/or body; b) metal nuts which derive their prevailing-torque characteristics from the addition or fusion of a nonmetallic insert, plug, or patch in their threads; and c) top insert, two-piece construction nuts which derive their prevailing-torque characteristics from an insert, usually a full ring of nonmetallic material, located and retained in the nut at its top surface.

There are three grades of prevailing-torque type steel hex nuts designated as Grades A, B and C, respectively in accordance with Industrial Fastener Institute (IFI) Specification IFI-100 and 101. There are two grades of prevailing-torque type steel hex flange nuts designated respectively as Grades F and G. Each grade of nut for use with externally threaded components has specified minimum tensile strengths. Nuts can be made of steel in accordance with IFI-140. Grade A nuts are typically not heat treated. Other nut grades may be heat treated as necessary to meet mechanical and performance requirements. Nuts may be furnished plain, i.e., as bare metal or with a protective coating if desired.

The portion of the nut containing the prevailing-torque feature may have a special contour within the maximum permitted width across flats and thickness. The minimum width across flats shall not apply at depressed portion of nut at prevailing-torque features.

Threads of nuts are Unified coarse (UNC) or Unified fine (UNF) series, as specified in ASME B1.1 and may also be dimensioned to corresponding metric threads as detailed in other documents and specifications as well, except that the portion of the threaded length containing the prevailing-torque element need not conform. Unless otherwise specified, nuts are typically tapped to Class 2B tolerances.

All-metal locknuts provide locking action through the triangular displacement of threads in the collar or conical top section of the nut, depending on the basic style chosen. The locking feature is obtained during manufacture by a crimping process which applies precision angular compression to the chamfered top or collar surface of the nut at three points.

The locknut starts on an externally threaded mating part like any ordinary nut, but as the bolt enters the threads in the compressed top section this out-of-roundness is displaced to a more circular form. Prevailing locking torque is thus provided as the three-way displacement engages the bolt threads through a resilient gripping action, without galling.

The nut does not have to seat to provide gripping action. It also can withstand severe vibration without loosening, and is reusable. Further advantages include trouble free thread starts with consistent, repeatable torque performance and uniform clamping force.

Existing locknuts can have a nylon insert positioned adjacent one of the upper and lower ends of the locknut. The locknut serves to hold a piston in place within a cylinder. The piston rod protrudes through the nut. If the piston rod is required to or accidentally bottoms out on the end of the cylinder it would or could cause damage to the cylinder, the rod, and the rod nut. This kind of damage could further ruin and damage the entire cylinder assembly.

Thus, there is a need for a lock nut with a segmented nylon ring which can be oriented and positioned in various positions or configurations between the top and bottom of the locknut to prevent damage to an end of the locknut, the ring, piston or the end of the cylinder.

Other aspects of the disclosure will become apparent upon a further reading of the following detailed description taken in conjunction with the drawings.

### SUMMARY OF THE DISCLOSURE

The disclosure relates to locknuts. More particularly, it relates to a prevailing torque lock nut with a segmented nylon insert.

In accordance with one aspect of the disclosure, a locknut and ring assembly has a locknut including a body having an internal bore having threads therein; the threads extend between first and second opposed outer ends of the locknut; a groove formed in the internal bore at one of at least several positions spaced from the first and second opposed ends; and a locking insert inserted into the groove.

In accordance with another aspect of the disclosure, a segmented ring for use with a locknut has a body having a curved inner surface and a curved outer surface, the body formed of elastic material; wherein the body has a slit formed therethrough to aid in inserting the ring into a groove of the locknut between opposed ends of the locknut.

Another aspect of the lock nut is a segmented nylon ring which can be oriented and positioned in various positions or configurations between the top and bottom of the locknut to prevent damage to an end of the locknut, the ring, piston or the end of the cylinder.

Another aspect of the disclosure is an elastic locking collar or nylon ring for a self-locking nut which has the following characteristics: (1) minimum water absorption; (2) dimensional stability under varying conditions of temperature and humidity; (3) good elastic recovery so that there is no appreciable reduction in the frictional grip against removal of the nut upon repeated re-use of the nut; and (4) resistance to damage to the surface of the ring when it is turned in contact with the screw threads.

In accordance with still another aspect of the disclosure, the locking collar or ring has good dimensional stability under varying conditions of humidity. The nylon ring has elastic recovery or spring-back so that there is a limited drop in the torsional resistance to removal of the nut even after several re-applications of the nut. The nylon ring also has locking characteristics not deleteriously affected by temperatures up to 250° F., which effectively covers the temperatures encountered by most lock nut applications.

Other aspects of the disclosure will become apparent upon a further reading of the following detailed description taken in conjunction with the drawings.

### BRIEF DESCRIPTION OF THE DRAWINGS

FIG. 1 is a perspective view of a locknut with a segmented ring positioned therein in accordance with a preferred embodiment of the present disclosure;

FIG. 2 is an exploded perspective view of a locknut and segmented ring in accordance with a preferred embodiment of the present disclosure;

FIG. 3 is a partial enlarged side elevational view of a locknut with a segmented ring positioned therein in accordance with a preferred embodiment of the present disclosure;

FIGS. 4A and 4B are a top plan view and a side elevational cross-sectional view of a nut with a segmented ring in accordance with a preferred embodiment of the disclosure; and

FIGS. 5A and 5B are a side elevational cross-sectional view and a top plan view of a segmented ring in accordance with a preferred embodiment of the disclosure.

### DETAILED DESCRIPTION OF THE DISCLOSURE

Prevailing torque locknuts can have a nylon insert inserted therein. Nylon insert locknuts can be preferably fabricated of either low carbon, medium carbon, or alloy materials, heat treated to various grades (or hardness).

A molded nylon insert allows the locknut to withstand severe vibration while providing a leak-resistant seal between mating threads. The nylon insert locknut is also less subject to thread galling than all-metal locknuts and features a more predictable torque performance plus extensive reusability.

The infinite adjustment inherent in the locknut combined with the low bearing surface runout assure proper axial loading for the most demanding applications. Locking effectiveness is maintained at peak temperatures up to 250° F. due to the resiliency and “elastic memory” characteristics of the heat stabilized Type 6/6 nylon used in the molded inserts. Higher temperature nylon inserts can also be used if desired.

The prevailing-torque developed by a locknut is the torque necessary to rotate the nut on its mating externally threaded component with the locking element fully engaged and torque being measured while the nut is in motion, with no axial load in the mating component.

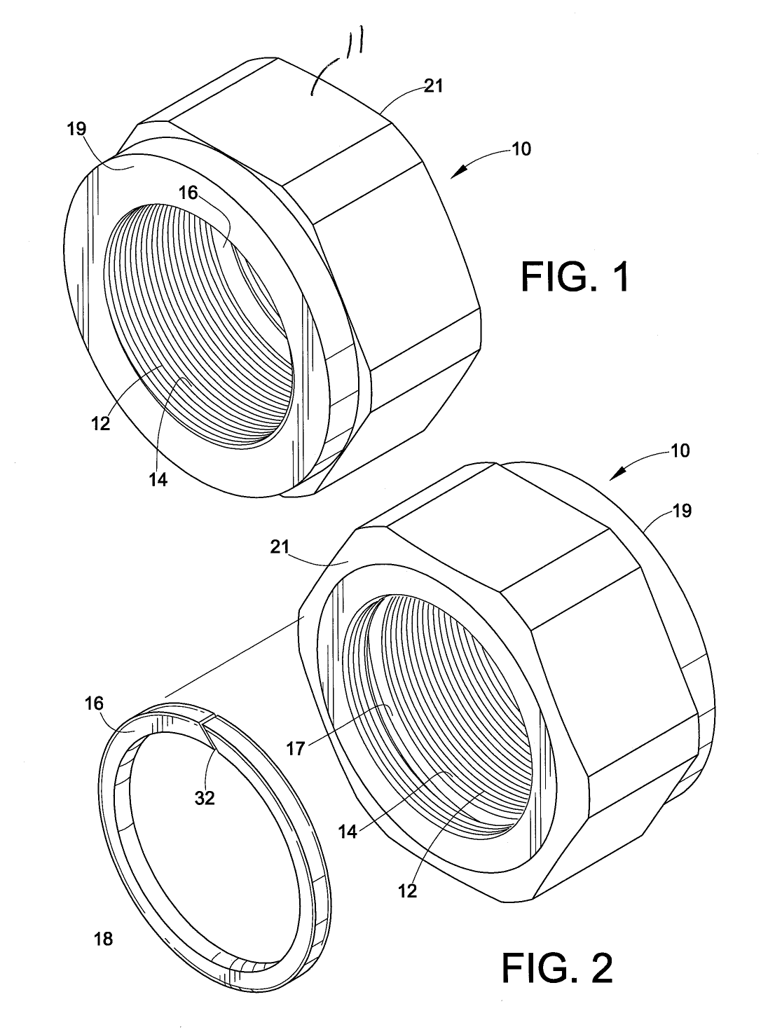

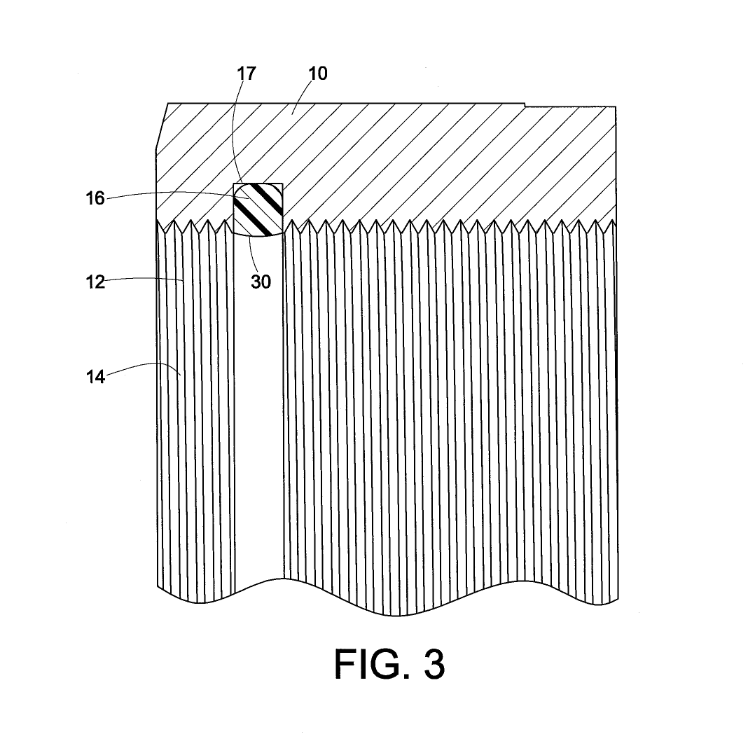

Referring now to FIGS. 1-5B, a locknut with a segmented nylon ring in accordance with a preferred embodiment of the disclosure is shown. The figures show one example of the assembly. Other configurations and dimensions are contemplated by the disclosure.

Referring now to FIGS. 1-3, a locknut 10 has a body 11 preferably made of metal, having a threaded bore portion 12 having internal female threads 14 formed therein. A locking ring 16 of elastic, non-metallic material, preferably nylon, is inserted into the threaded bore portion by being press-fit into an annular groove 17 formed between threads 14 within bore 12. An inner bore 18 of the ring 16 is somewhat smaller than the major diameter of the thread 14, that is the minimum diameter of the ring 16 is greater than the minor diameter of threads 14, so that when the nut is screwed on a bolt, the bolt thread impresses a thread in the ring. The ring becomes confined between the walls of the thread bore portion and the threaded wall of the bolt when the nut is applied. The groove 17 is preferably positioned away from opposed outer ends 19, 21 of the locknut to avoid damage to the ring. It is contemplated by the disclosure that groove 17 can be located along numerous locations between outer ends of the nut within bore 12. Preferably, the groove 17 is spaced away from the opposed outer ends of the nut to prevent damage to the insert, the piston rod, the cylinder, and the piston rod nut.

An elastic locking collar or nylon ring for a self-locking nut preferably has the following characteristics: (1) minimum water absorption; (2) dimensional stability under varying conditions of temperature and humidity; (3) good elastic recovery so that there is no appreciable reduction in the frictional grip against removal of the nut upon repeated re-use of the nut; and (4) resistance to damage to the surface of the ring when it is turned in contact with the screw threads.

Furthermore, a locking collar or ring of nylon material has good dimensional stability under varying conditions of humidity. The nylon ring 16 preferably has elastic recovery or spring-back so that there is a limited drop in the torsional resistance to removal of the nut even after several re-applications of the nut. The nylon ring also preferably has locking characteristics not deleteriously affected by temperatures up to 250° F., which effectively covers the temperatures encountered by most lock nut applications.

Referring now to FIGS. 2, 3, 4A, 4B, 5A and 5B, the inner diameter D of the segmented nylon ring (for example, about 3.182 inches) will not protrude inwardly from the minor diameter of the threaded bore portion 12 of the nut, and may have an inner or minor diameter slightly larger than the minor diameter of the threads 14.

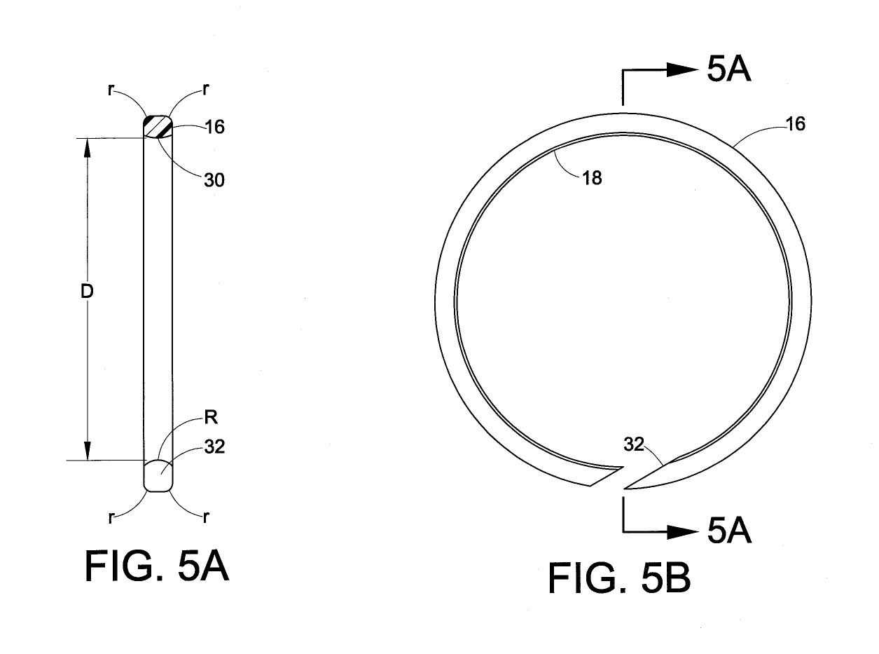

As seen in FIGS. 5A and 5B, the ring may have a curved inner surface 30 with a radius R of about 0.375 inches. A slit or slot 32 (forming an opening about 0.187 inches) is preferably formed through the ring thereby forming a segmented ring to facilitate conforming, bending or compressing the ring to fit within groove 17 of the inner diameter of the threaded bore portion of the nut.

Outer edges of the ring have a curved surface within a radius r of about 0.078 inches. Slot 32 may be cut at an angle of about 60 degrees to the ring or at other suitable angles.

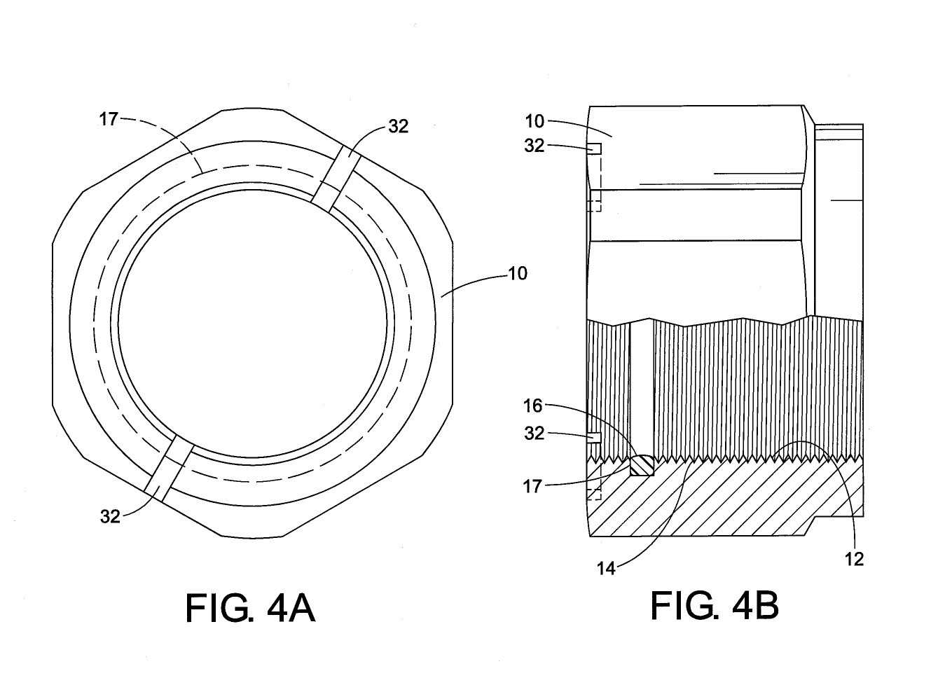

The nut is preferably fabricated from steel of various alloys having a hardness. For example, the nut can be fabricated from 1045 or 4140 alloy steel with a hardness of Rc 22-30. Other alloys and hardnesses are contemplated by the disclosure. The nut is preferably coated with zinc phosphate and oil. Referring to FIGS. 4A and 4B, an oil drain slot 34 can be provided to aid in draining excess oil out of and away from the locknut. Other slots or openings to drain oil from the locknut are also contemplated by the disclosure. The ring is preferably fabricated of a blue color material but can also be white or any suitable color. The ring material has an elastic memory such that when it is installed in the nut it returns to its original shape.

Existing locknuts can have a nylon insert positioned adjacent to the upper and lower ends of the locknut. The locknut which serves to hold a piston in place within a cylinder can potentially bottom out on the end of the cylinder. The nut abuts a flat surface of the cylinder which may cause damage to the cylinder, the piston or the nut. The nylon insert of the present disclosure provides locking action so as the nut is threaded the ring provides locking action. The insert is located in such a way to prevent damage to the insert, the piston rod, the cylinder, and the piston rod nut.

Thus, an advantage of the present disclosure is a lock nut with a segmented nylon ring which can be positioned between a top and bottom of the locknut to prevent damage to an end of the locknut, the ring, piston or end of the cylinder, and provide locking action for the locknut.

The exemplary embodiment has been described with reference to the preferred embodiments. Obviously, modifications and alterations will occur to others upon reading and understanding the preceding detailed description. It is intended that the exemplary embodiment be construed as including all such design modifications and alterations insofar as they come within the scope of the appended claims or the equivalents thereof.

1. A locknut and insert assembly comprising:
a locknut including a body having an internal bore having threads therein;
said threads extend between first and second opposed outer ends of said locknut;
a groove formed in said internal bore at one of at least several positions spaced from said first and second opposed ends; and a locking insert inserted into said groove.

2. The locknut and insert assembly of claim 1, wherein said locknut is a prevailing torque locknut.

3. The locknut and insert assembly of claim 1, wherein said locking insert comprises elastic, non-metallic material.

4. The locknut and insert assembly of claim 1, wherein said locking insert is a ring fabricated from nylon.

5. The locknut and insert assembly of claim 1, wherein said locknut is fabricated from metal.

6. The locknut and insert assembly of claim 1, wherein said locking insert is press fit into said groove.

7. The locknut and insert assembly of claim 1, wherein said locking insert has a minor diameter at least slightly greater than a minor diameter of said internal threads when said insert is inserted into said groove.

8. The locknut and insert assembly of claim 1, wherein said locknut is fabricated from alloy steel with a hardness of Rc22-30.

9. The locknut and insert assembly of claim 1, wherein said insert has a curved inner surface.

10. The locknut and insert assembly of claim 1, wherein said insert has a curved outer surface.

11. The locknut and insert assembly of claim 1, wherein said insert comprises a ring having a slit formed therethrough to facilitate compression of said ring.

12. The locknut and insert assembly of claim 11, wherein said ring slit is formed at an angle of about 60 degrees.

13. The locknut and insert assembly of claim 1, wherein said locknut compresses a drain slot for draining excess oil from said locknut.

14. A segmented locking ring for use with an associated locknut, comprising:
a body having a curved inner surface and a curved outer surface, said body formed of elastic material;
wherein said body comprises a slit formed therethrough to aid in inserting said ring into a groove of said associated locknut spaced from opposed ends of said associated locknut.

15. The ring of claim 14, wherein said locking ring is fabricated from nylon.

16. The ring of claim 14, wherein said locking ring has a minimum diameter at least slightly greater than a minor diameter of internal threads of said associated locknut when said ring is inserted into said groove.

17. The ring of claim 14, wherein said ring slit is formed at an angle of about 60 degrees.
